(19) United States
(12) Patent Application Publication
(10) Pub. No.: US 2025/0149869 A1
(43) Pub. Date: May 8, 2025

(54) WIRE STRIPPER

(71) Applicant: Chien-Ta HUANG, New Taipei City (TW)

(72) Inventor: Chien-Ta HUANG, New Taipei City (TW)

(21) Appl. No.: 18/808,759

(22) Filed: Aug. 19, 2024

(30) Foreign Application Priority Data
Nov. 6, 2023 (TW) 112212001

(51) Int. Cl. H02G 1/12

(52) U.S. Cl. CPC H02G 1/1212

(57) ABSTRACT

A wire stripper including: a plier head having a pair of cutting portions having a plurality of pairs of semicircular jaws; and a handle assembly having a pair of arms pivoted to the plier head; where the pair of arms have a positioning member and a cutting member opposing each other at upper inner sides thereof, the positioning member being provided with a transverse groove and a longitudinal groove, the cutting member having a round cutting edge, and the round cutting edge being aligned with the transverse groove.

### BACKGROUND OF THE INVENTION

### Field of the Invention

The invention relates to a wire stripper, especially to a wire stripper applicable to thicker cables

### Description of the Related Art

A general wire stripper has a plier head, a pivot and a handle assembly, where the plier head has a pair of edges and the pair of edges is provided with a plurality of pairs of semicircular jaws for stripping cables with different diameters.

However, when a user needs to strip a thicker cable, the jaws of the general wire stripper are likely not able to open wide enough to hold the cable and thereby cannot strip the thicker cable successfully.

To solve the aforementioned problem, a novel wire stripper is urgently needed in the field.

### SUMMARY OF THE INVENTION

One objective of the present invention is to disclose a wire stripper capable of stripping thicker cables.

Another objective of the present invention is to disclose a wire stripper, which is capable of providing different stripping depths by means of an eccentrically disposed round cutting edge, thereby capable of stripping a variety of thicker cables.

To attain the foregoing objectives, a wire stripper is proposed which includes:
a plier head having a pair of cutting portions, the pair of cutting portions having a
plurality of pairs of semicircular jaws; and
   a handle assembly pivoted to the plier head;
   where the handle assembly has a pair of arms, the pair of arms have a positioning member and a cutting member opposing each other at upper inner sides thereof, the positioning member being provided with a transverse groove and a longitudinal groove, the cutting member having a round cutting edge, and the round cutting edge being aligned with the transverse groove.

In one embodiment, the positioning member and the cutting member are each secured to one of the pair of arms by a screw member.

In one embodiment, the positioning member is made of plastic.

In one embodiment, the round cutting edge is made of metal.

In one embodiment, the cutting member further includes a rotatable spacer having an eccentric pivot and a plurality of rotatable positioning points for adjusting a distance between the cutting member and the positioning member to provide a plurality of different stripping depths.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 shows a schematic diagram of one embodiment of the wire stripper of the present invention;

FIG. 2 illustrates a first application of the wire stripper of FIG. 1;

FIG. 3 illustrates a second application of the wire stripper of FIG. 1; and

FIG. 4 shows a schematic diagram of another embodiment of the wire stripper of the present invention.

### DETAILED DESCRIPTION OF THE PREFERRED EMBODIMENTS

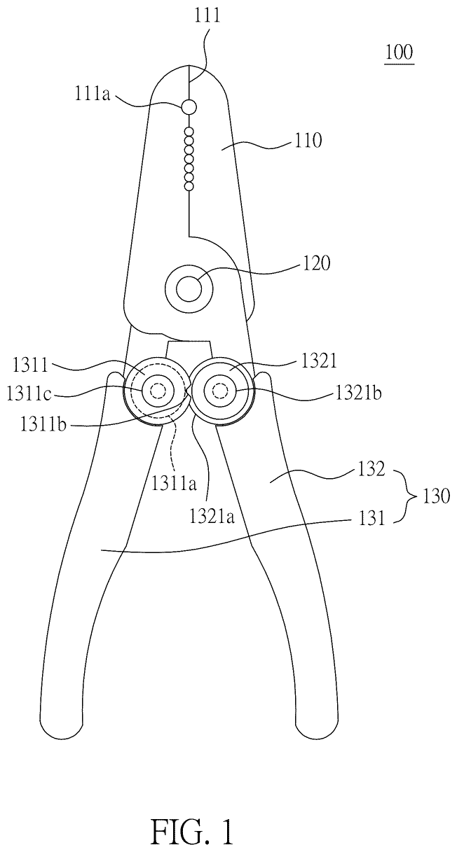

Please refer to FIG. 1, which shows a schematic diagram of one embodiment of the wire stripper of the present invention.

As illustrated in FIG. 1, a wire stripper 100 includes a plier head 110, a pivot 120, and a handle assembly 130, where the handle assembly 130 is pivoted to the plier head 110 by means of the pivot 120.

The plier head 110 includes a pair of cutting portions 111 having a plurality of pairs of semicircular jaws 111a to hold a variety of thinner cables with different diameters. That is, the plier head 110 of the wire stripper 100 can be used for stripping generally thinner cables.

The handle assembly 130 has a pair of arms (131,132) provided with a positioning member 1311 and a cutting member 1321 opposing each other at upper inner sides of the pair of arms (131,132), the positioning member 1311 being provided with a transverse groove 1311a and a longitudinal groove 1311b substantially perpendicular to the transverse groove 1311a, the cutting member 1321 having a round cutting edge 1321a, and the round cutting edge 1321a being aligned with the transverse groove 1311a.

In addition, in this embodiment, the positioning member 1311 is secured to the arm 131 by a screw member 1311c, and the cutting member 1321 is secured to the arm 132 by a screw member 1321b; the positioning member 1311 may be made of plastic, and the round cutting edge 1321a may be made of metal.

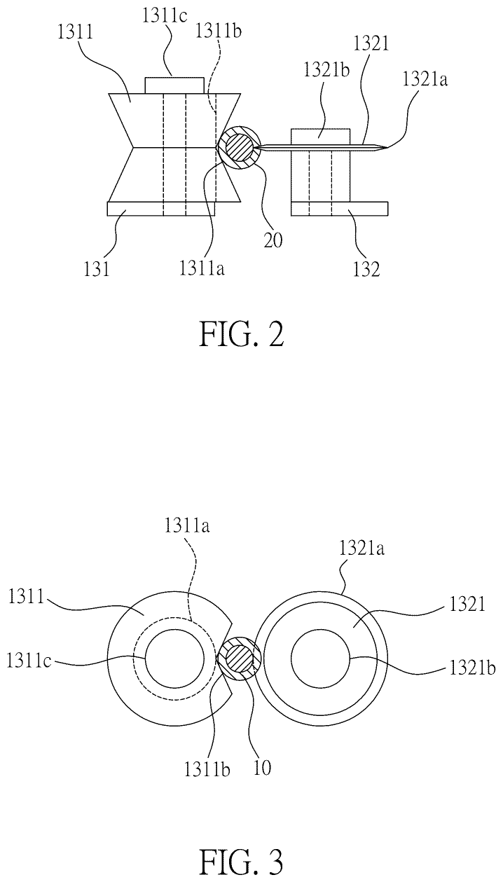

Please refer to FIG. 2, which illustrates a first application of the wire stripper of FIG. 1. As illustrated in FIG. 2, a cable 10 is placed in the transverse groove 1311a with its plastic covering cut by the round cutting edge 1321a when a user closes the pair of arms (131,132).

Please refer to FIG. 3, which illustrates a second application of the wire stripper of FIG. 1. As illustrated in FIG. 3, a cable 20 is placed in the longitudinal groove 1311b with its plastic covering cut by the round cutting edge 1321a when a user closes the pair of arms (131,132).

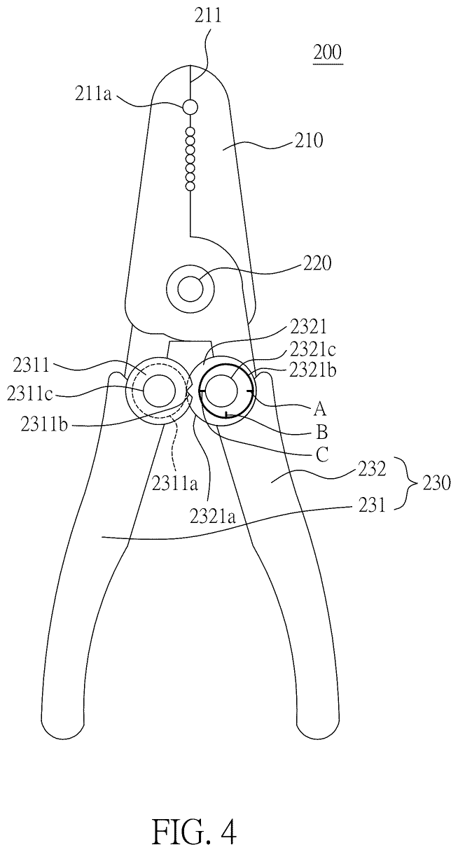

Please refer to FIG. 4, which shows a schematic diagram of another embodiment of the wire stripper of the present invention. As illustrated in FIG. 4, a wire stripper 200 includes a plier head 210, a pivot 220 and a handle assembly 230, where the handle assembly 230 is pivoted to the plier head 210 by means of the pivot 220.

The plier head 210 includes a pair of cutting portion 211 having a plurality of pairs of semicircular jaws 211a for holding a variety of thinner cables of different diameters.

The handle assembly 230 has a pair of arms (231,232) provided with a positioning member 2311 and a cutting member 2321 opposing each other at upper inner sides of the pair of arms (231,232), the positioning member 2311 being provided with a transverse groove 2311a and a longitudinal groove 2311b substantially perpendicular to the transverse groove 2311a, the cutting member 2321 having a round cutting edge 2321a and a rotatable spacer 2321b, and the round cutting edge 2321a being aligned with the transverse groove 2311a.

In addition, in this embodiment, the positioning member 2311 is secured to the arm 231 by a screw member 2311c, and the cutting member 2321 is secured to the arm 232 by a screw member 2321b; the positioning member 2311 may be made of plastic, and the round cutting edge 2321a may be made of metal.

It is to be noted that the screw member 2321c serves as an eccentric pivot of the rotatable spacer 2321b, and the rotatable spacer 2321b has a plurality of rotatable positioning points (A, B, and C) for adjusting a distance between the cutting member 2321 and the positioning member 2311 to provide a plurality of different stripping depths. That is, when a user rotates the rotatable spacer 2321b to different rotatable positioning points (A, B, or C), the rotatable spacer 2321b will have different distances with the positioning member 2311 to determine different depths for the round cutting edge 2321a to cut into a cable.

With the designs disclosed above, the present invention has the following advantages:
1. The wire stripper of the invention can be used to strip thicker cables; and
2. The wire stripper of the invention can provide different stripping depths by means of an eccentrically pivoted round cutting edge, thereby suitable for stripping a variety of thicker cables.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance over the conventional structure and further complies with the patent application requirements and is submitted to the Patent and Trademark Office for review and granting of the commensurate patent rights.

What is claimed is:

1. A wire stripper comprising:
a plier head having a pair of cutting portions, the pair of cutting portions having a plurality of pairs of semicircular jaws; and
a handle assembly pivoted to the plier head;
where the handle assembly has a pair of arms, the pair of arms have a positioning member and a cutting member opposing each other at upper inner sides thereof, the positioning member being provided with a transverse groove and a longitudinal groove, the cutting member having a round cutting edge, and the round cutting edge being aligned with the transverse groove.

2. The wire stripper as disclosed in claim 1, wherein the positioning member and the cutting member are each secured to one of the pair of arms by a screw member.

3. The wire stripper as disclosed in claim 1, wherein the positioning member is made of plastic.

4. The wire stripper as disclosed in claim 1, wherein the round cutting edge is made of metal.

5. The wire stripper as disclosed in claim 1, wherein the cutting member further includes a rotatable spacer having an eccentric pivot and a plurality of rotatable positioning points for adjusting a distance between the cutting member and the positioning member to provide a plurality of different stripping depths.
